(19) United States
(12) Patent Application Publication
(10) Pub. No.: US 2005/0289293 A1
(43) Pub. Date: Dec. 29, 2005

(54) Dual-port DRAM cell with simultaneous access

(76) Inventors: Michael C. Parris, Colorado Springs, CO (US); Douglas B. Butler, Colorado Springs, CO (US)

Correspondence Address: HOGAN & HARTSON LLP, ONE TABOR CENTER, SUITE 1500, 1200 SEVENTEENTH ST, DENVER, CO, 80202, US

(21) Appl. No.: 10/878,802

(22) Filed: Jun. 28, 2004

(51) Int. Cl. G06F 12/00

(52) U.S. Cl. 711/106

(57) ABSTRACT

A dual-port memory substantially eliminates noise problems associated with the staggered methods of operation. The first and second word lines of a dual-port memory cell are simultaneously activated, such that all four bit lines associated with the cell also move at the same time. The dual-port memory uses simple control logic circuitry without the need for additional external control signals. There are no lock-out times or write restrictions with the method of the present invention. The dual-port memory of the present invention includes a method for hiding refresh, and a method for increasing operating speed.

### BACKGROUND OF THE INVENTION

The present invention relates, in general, to the field of integrated circuit memories. More particularly, the present invention relates to a dual-port integrated circuit memory architecture and method of operation.

A standard single-port or “1T/1C” DRAM cell 10 is shown in FIG. 1. DRAM cell 10 includes a pass transistor 18 and storage capacitor 22. Cell 10 further includes a word line 16 coupled to the gate of transistor 18, as well as a bit line 12 and complementary bit line 14. Bit line 12 is coupled to the drain of transistor 18, and complementary bit line 14 is coupled to the drain of transistors in other 1T/1C cells in an array of cells (not shown in FIG. 1).

A standard dual-port or “2T/1C” DRAM cell 20 is shown in FIG. 2. DRAM cell 20 includes two pass transistors 34 and 36 each coupled to storage capacitor 38. Cell 20 further includes a word line 42 coupled to the gate of transistor 34, and an additional word line 44 coupled to the gate of transistor 36. Cell 20 also includes a set of two bit lines 24 and 28, as well as two complementary bit lines 26 and 32. Bit line 24 is coupled to the drain of transistor 34 and bit line 28 is coupled to the drain of transistor 36. Complementary bit lines 26 and 32 are coupled to the drains of transistors in other 2T/1C cells in an array of cells (best seen in FIG. 3). Bit lines 24 and 26 and word line 42 are associated with port A. Bit lines 28 and 32 are associated with a second port and method for accessing the cell referred to as port B.

Referring now to FIG. 3, a portion 30 of an array of 2T/1C memory cells is shown. The array portion 30 includes two rows and three columns of cells in order to show the bit line and word line connections. In the first row of cells, cells 20A and 20C are connected to the two bit lines in the first set of bit lines 46. Cell 20B is connected to the two complementary bit lines in the first set of bit lines 46. In the second row of cells, cells 20D and 20F are connected to the two bit lines in the second set of bit lines 48. Cell 20E is connected to the two complementary bit lines in the second set of bit lines 48. A first set of two word lines is coupled to a first column of cells that includes cells 20A and 20D, a second set of two word lines is coupled to a second column of cells that includes cells 20B and 20E, and a third set of two word lines is coupled to a third column of cells that includes cells 20C and 20F. The interconnection pattern shown in FIG. 3 is extended as required to accommodate the number of rows and columns of cells in the entire array.

The standard DRAM cell 10 shown in FIG. 1 operates according to a simultaneous access method in which disturb problems between cells in the array are minimized. However, many prior art techniques use a staggered access method for operating the dual-port DRAM cell 20 shown in FIG. 2 for refresh or read/write operations. This type of access can lead to noise problems and data disturbs, whereby some memory cells are being sensed while others in the same sub-array are being restored, causing noise between sets of memory cells.

Referring now to FIG. 4, a portion 40 of a dual-port 2T/2C memory array is shown in greater detail. In particular, sense amplifiers 52, 54, 56, and 58 are shown for resolving the data state of a pair of bit lines. The actual physical location of the sense amplifiers 52-58 in the integrated circuit may be different from that shown in FIG. 4. In addition, FIG. 4 shows parasitic capacitors 53, 55, and 57 that can act as signal paths for undesirably affecting the data state of a selected memory cell or bit line in the array.

The disturb problem for a staggered access of a dual-port memory array is shown in greater detail in the timing diagram 50 of FIG. 5. The word line signal 62 is shown for accessing the first port of the memory. The word line signal 64 is also shown for accessing the second port of the memory, which is delayed in time by one-half of a clock cycle. The bit line waveforms 66 and 68 are shown for the first port. The bit line waveforms include a first portion in which the bit line signal is developed, and a second portion in which the bit line signal is resolved by the sense amplifiers. The bit lines waveforms 72 and 74 are delayed by one-half of a clock cycle in response to the word line waveforms. This type of consecutive access to the dual-port cell can lead to disturb problems. A critical sensing time 76 occurs when a bit line signal for the first port of the memory is being resolved when a bit line signal is being developed for the second port of the memory. The large bit line signal on the first port can undesirably affect the data state of the developing signal on the second port, which does not normally occur for single port memories using simultaneous access.

What is desired, therefore, is a simple and cost effective dual-port memory architecture and method of operation that eliminates the disturb problems associated with the prior art staggered method of operating a dual-port memory.

### SUMMARY OF THE INVENTION

According to the present invention an architecture and method of operation for a dual-port memory substantially eliminates the noise problems associated with the known staggered methods of operation. The architecture and method of operation of the dual-port memory of the present invention has substantially the same immunity to disturb and noise problems as that found in conventional 1T/1C single-port DRAMs widely used today.

In a preferred method of operation, the first and second word lines of a dual-port memory cell are activated at the same time, such that all four bit lines associated with the cell also move at the same time. This then confers the same noise immunity as a conventional 1T/1C DRAM where all the cells are sensed at the same time along a single word line in a given sub-array, and disturb problems are minimized.

The dual-port memory of the present invention uses simple control logic circuitry without the need for additional external control signals. There are no lock-out times or write restrictions with the method of the present invention as are found in prior art designs.

The dual-port memory of the present invention includes a first embodiment for hiding refresh, and a second embodiment for increasing operating speed.

In the first embodiment for hiding refresh, port A is used to read or write to the memory cell. Port B is used for refresh. An on-chip address generator is used together with a refresh timer to generate the refresh address. The refresh address, if required, and the read/write address are compared. If they are different, they are applied to the row decoders at the same time so that the word line on port A and the word line on port B to different cells will be activated at the exact same time. If the refresh address and read/write address are the same, then no refresh is required and the word line on port B is inactive.

Word line B, therefore, is allowed to go high only if the word line address is different from the word line A address. If they are the same the cell has been refreshed by word line A. If both word line A and word line B go high in the same cell, the bit line signal is cut in half, and only one of the ports is activated.

The comparison of the word line A and word line B addresses can be done during the address setup time of the memory and does not materially impact overall operating speed.

In the second embodiment, the two ports of the memory cell can be operated to substantially increase operating speed. In the case of the dual-port memory, operating speed is effectively doubled. In this embodiment, external addresses come into the memory at twice the rate of the word line cycle rate. Latency is used to compare the high speed addressing so that if two consecutive word line addresses are the same, only one of the ports of the dual port cell is selected. If the two addresses are different, both port A and port B word lines go active simultaneously, and data can be read or written into the selected cells.

Clock latency allows two consecutive row addresses to be compared. If the addresses are different, port A and B of the memory are used at one-half rate. If they are the same, then only port A is used. Data can be written and read at full rate. Internal word line or RAS cycle times can run at a relaxed half-rate with the method of the present invention.

### BRIEF DESCRIPTION OF THE DRAWINGS

The aforementioned and other features and objects of the present invention and the manner of attaining them will become more apparent and the invention itself will be best understood by reference to the following description of a preferred embodiment taken in conjunction with the accompanying drawings, wherein:

FIG. 1 is a schematic diagram of a prior art single-port memory cell;

FIG. 2 is a schematic diagram of a prior art two-port memory cell;

FIG. 3 is a schematic diagram of a portion of a prior art two-port memory cell array;

FIG. 4 is a schematic diagram of the memory cell array portion of FIG. 3 further including sense amplifiers and parasitic capacitance;

FIG. 5 is a timing diagram showing various waveforms in a prior art staggered method of operating a two-port memory;

FIG. 6 is a block diagram of a first embodiment of a dual-port memory according to the present invention;

FIG. 7 is a timing diagram associated with the dual-port memory of FIG. 6;

FIG. 8 is a block diagram of a second embodiment of a dual-port memory according to the present invention; and

FIG. 9 is a timing diagram associated with the dual-port memory of FIG. 8.

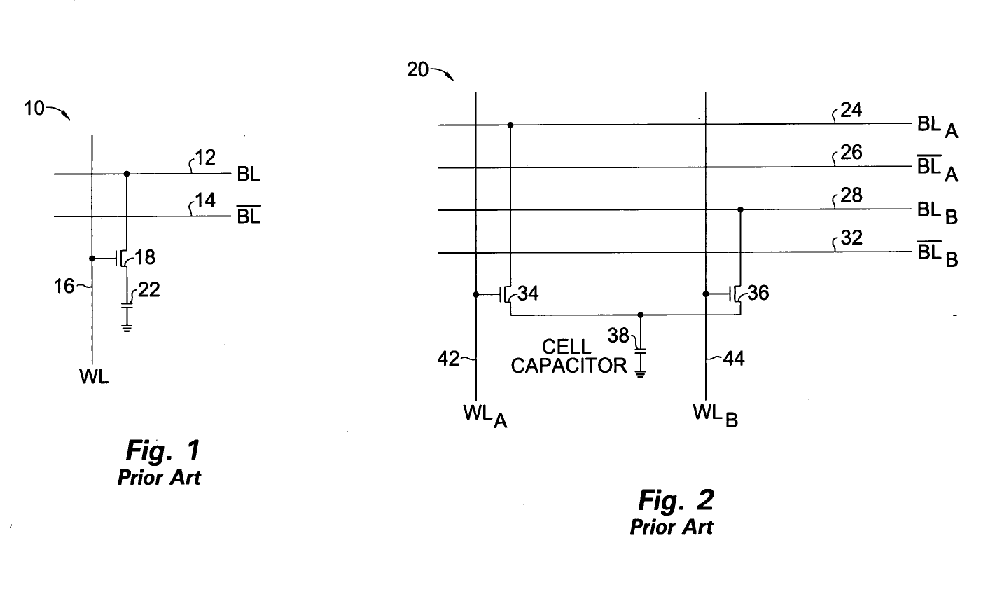

### DETAILED DESCRIPTION

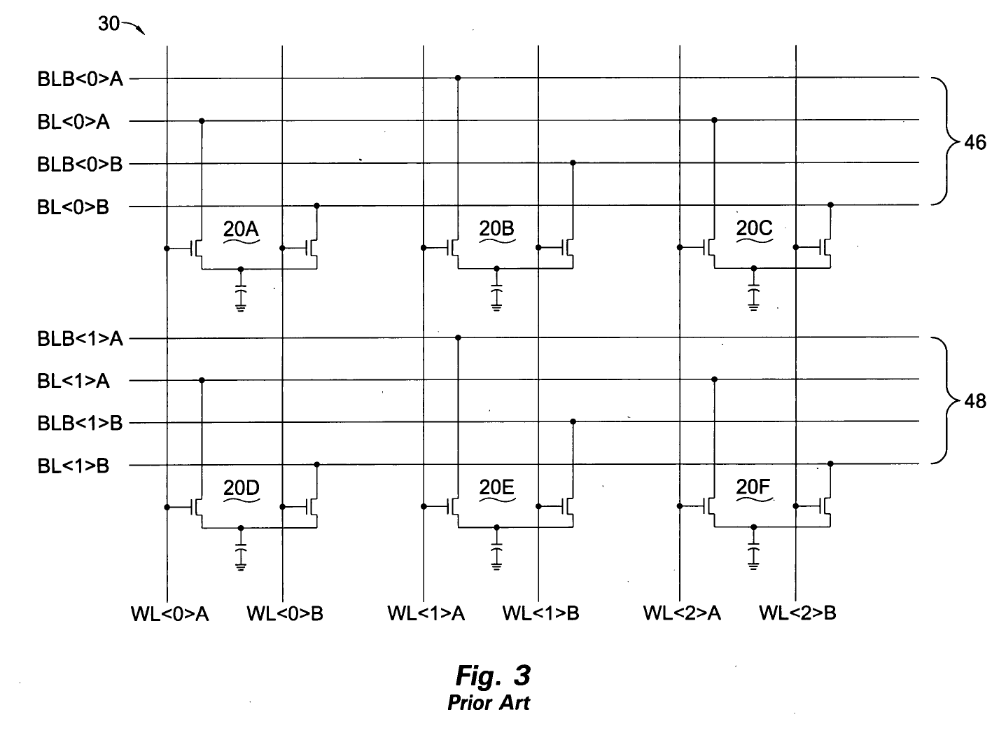

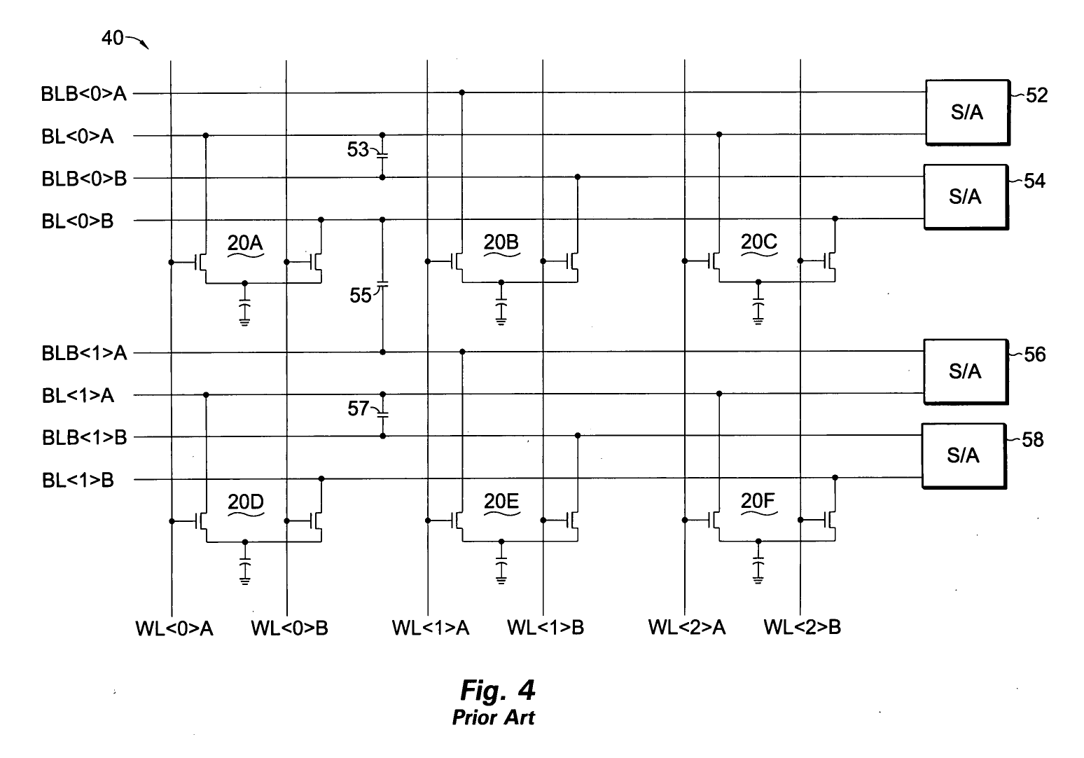

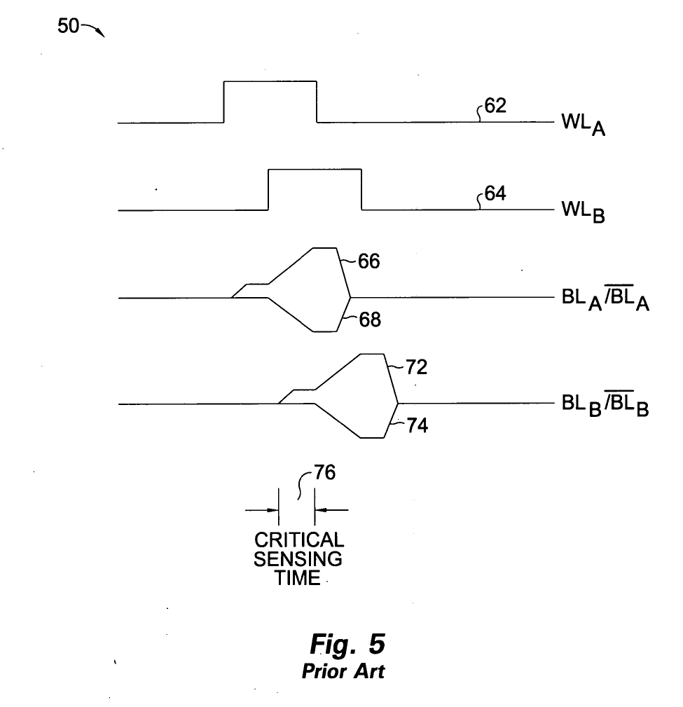

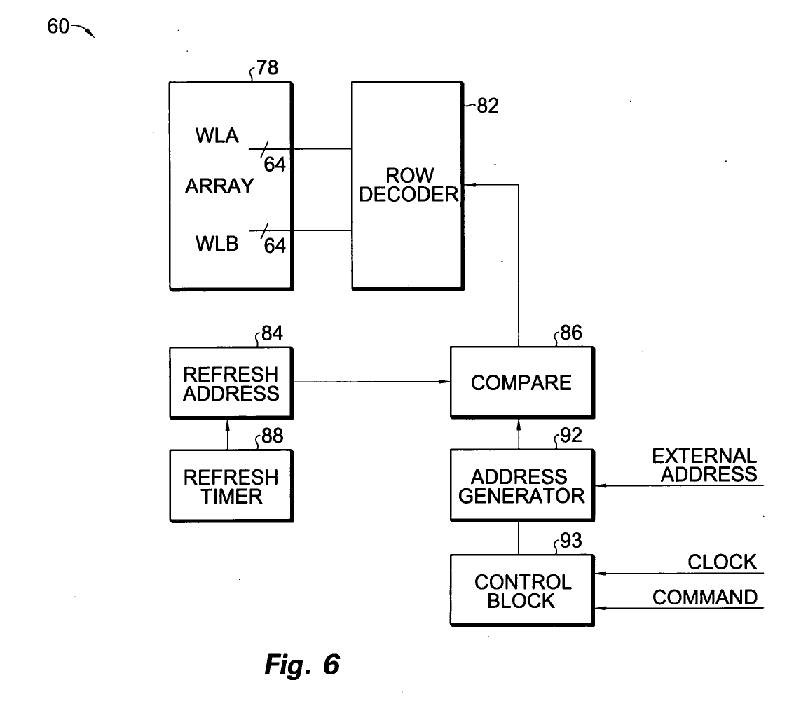

Referring now to FIG. 6, an integrated circuit memory 60 includes an array of dual-port memory cells 78 including first and second word line buses WLA and WLB, an address generator 92 for generating read/write addresses in response to addresses received on an external address bus, a refresh timer 88, a refresh address generator 84 having an input coupled to the refresh timer 88 and an output for generating refresh addresses, a comparator 86 for comparing the read/write addresses to the refresh addresses, and a row decoder 82 having an input coupled to the comparator 86, and first and second outputs for selectively driving the first and second word line buses WLA and WLB in response to the data state of the comparator 86. A logic control block 93 is also shown in FIG. 6. Logic control block receives the CLOCK and COMMAND signals, and provides a control signal output coupled to address generator 92. The WLA and WLB word line buses have a width of 64, 128, or 256 bits, although other widths can be used. The memory cells in memory array 78 are of the type shown in previous FIGS. 2 and 3.

The method of operating memory 60 includes reading or writing to a first port (A) of the dual-port memory cells in the array 78, refreshing at a second port (B) of the dual-port memory cells in the array, comparing a read/write address to a refresh address, and, if the read/write address and the refresh address are different, simultaneously activating a word line associated with the first port (A) of a first dual-port memory cell and a word line associated with the second port (B) of a second dual-port memory cell. For example, in FIG. 3, two different two-port memory cells could be memory cell 20A and memory cell 20B.

If the read/write address and the refresh address are the same, then only the word line associated with the first port (A) of the selected dual-port memory is activated. For example, in FIG. 3, only word line WLA for memory cell 20A is activated.

In the method of the present invention, comparing the read/write and refresh address can occur during a memory setup time so that memory speed is unaffected.

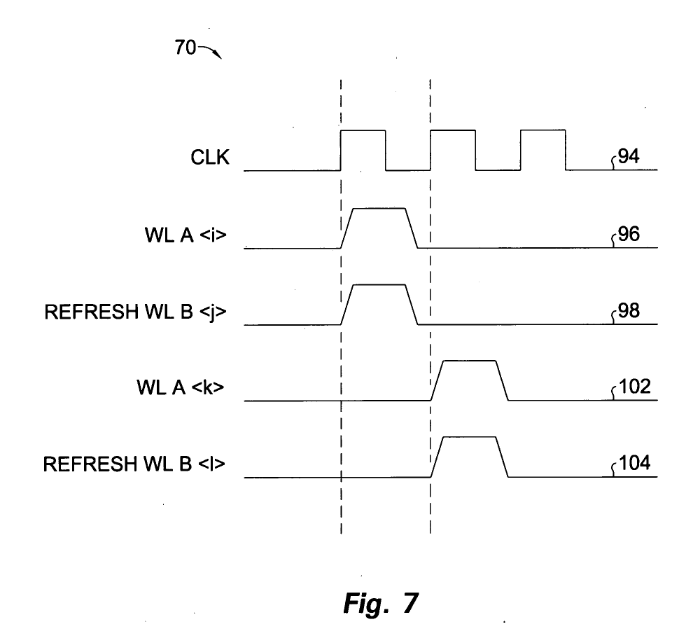

The method of the present invention is explained in further detail with respect to the timing diagram of FIG. 7. The clock signal for the memory 94 is shown in conjunction with four separate word line signals 96, 98, 102, and 104 for different memory cells. Note that the first and second port word line signals are always simultaneously activated. Word line signals 96 and 98 are associated with a first memory cycle and word line signals 102 and 104 are associated with a second memory cycle.

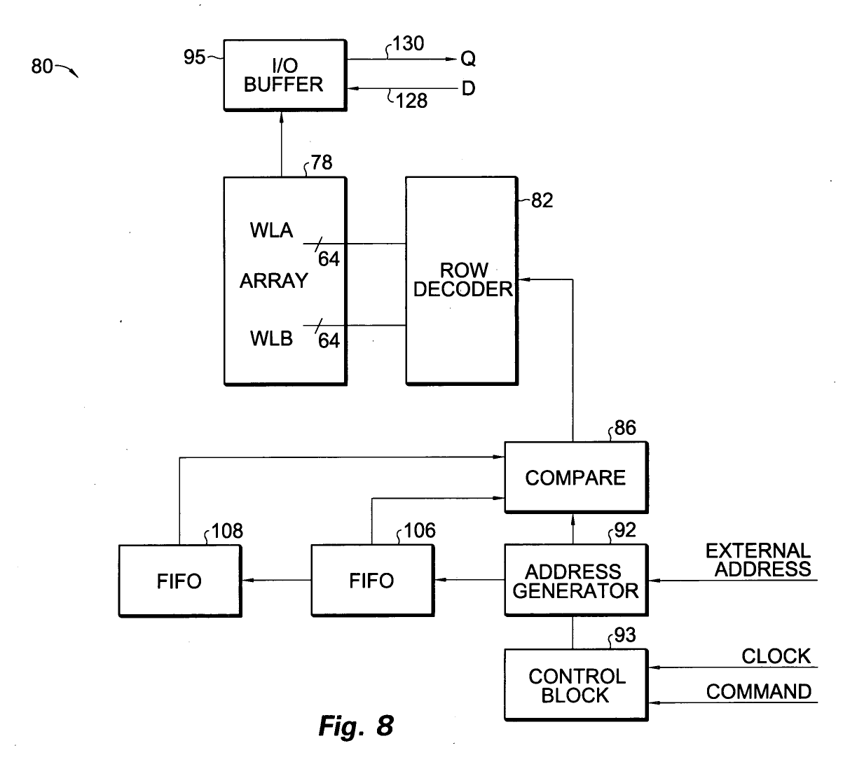

Referring now to FIG. 8, an integrated circuit memory 80 includes an array of dual-port memory cells 78 including first and second word line buses WLA and WLB, an address generator 92 for generating read/write addresses, a first FIFO 106 having an input coupled to the address generator 92 and first and second outputs, a second FIFO 108 having an input coupled to the first output of the first FIFO 106 and an output, a comparator 86 for comparing the second output of the first FIFO 106 to the output of the second FIFO 108, and a row decoder 82 having an input coupled to the comparator 86, and first and second outputs for selectively driving the first and second word line buses WLA and WLB in response to the data state of the comparator 86. A logic control block 93 is coupled to the address generator 92 and receives the CLOCK and COMMAND inputs signals. In memory 80, the first FIFO 106 provides a one-half clock cycle delay between the input and each of the first and second outputs. The second FIFO 108 also provides a one-half clock cycle delay between the input and the output. An I/O buffer 95 is also shown in FIG. 8, for receiving data input signal 128 and for providing the data output signal 130.

The method of operating memory 80 according to the present invention includes comparing a first read/write address to a second consecutive refresh address, and, if the first and second read/write addresses are different, simultaneously activating a word line associated with a first port (A) of a first dual-port memory cell and a word line associated with a second port (B) of a second dual-port memory cell. For example, in FIG. 3, two different two-port memory cells could be memory cell 20A and memory cell 20B.

If the first and second read/write addresses are the same, then only the word line associated with one of the ports of the selected dual-port memory is activated. For example, in FIG. 3, only word line WLA for memory cell 20A is activated.

The method of the present invention uses a latency of three to compare the first and second consecutive read/write addresses so that memory speed is unaffected. The effective improvement in the memory speed for the dual-port memory 80 shown in FIG. 8 is about a factor of two.

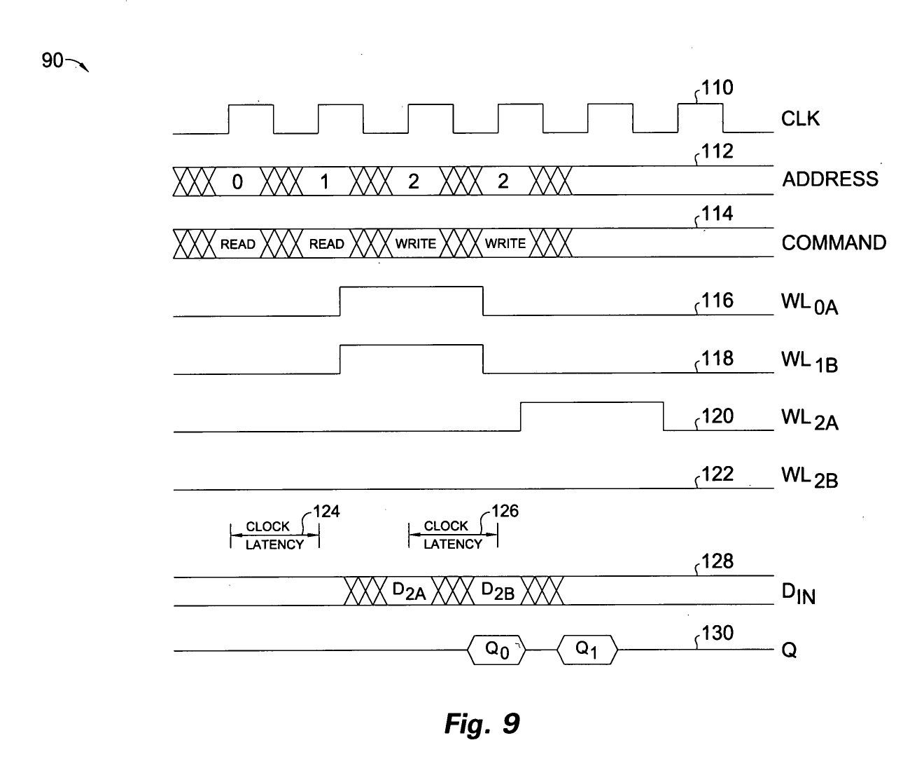

The method of the present invention is explained in further detail with respect to the timing diagram of FIG. 9. Timing diagram 90 includes a memory CLOCK signal 110. The ADDRESS and COMMAND buses 112 and 114 are shown. The ADDRESS bus includes the external addresses and the COMMAND bus includes information to request a READ, a WRITE or a NOP (no operation). One standard COMMAND bus includes decoded /CE and /WE signals. Another standard COMMAND bus includes /RAS, /CAS, and /WE signals. Four word line signals 116, 118, 120, and 122 are shown. Signals 116 and 118 illustrate the activation of word line signals for different memory cells in the array in the case of different consecutive read/write addresses, in this case two consecutive reads on addresses zero (0) and then one (1). Note that word line signal 116 is for activating the first port of a first memory cell with address zero (0) and word line signal 118 is for activating the second port of a second memory cell with address one (1). In contrast, word line signals 120 and 122 illustrate the activation of a signal word line signal for the same consecutive read/write address two (2). Note that only the first port word line signal 120 is activated, whereas the second port word line signal 122 remains inactive. Since the DIN, D2A, and D2B data word all correspond to the same address, only one word line needs to be selected and the second data word D2B is written into the cell. If both word lines are selected at the same time on the same for back-to-back reads, a failure would occur. The effective “half-charge”, since one cell capacitor is used for sets of bit lines, results in a failure to sense the correct data.

The clock latency periods 124 and 126 are shown for the first and second address comparisons. Note that a latency of three is used, because the read request is pipelined in serially into FIFOs 106 and 108, performed in parallel in array 78, and then pipelined out serially through I/O buffer 95.

Finally, the DIN data input signal 128 is received and the Q data output signal 130 is provided by I/O buffer 95.

While there have been described above the principles of the present invention in conjunction with specific memory architectures and methods of operation, it is to be clearly understood that the foregoing description is made only by way of example and not as a limitation to the scope of the invention. Particularly, it is recognized that the teachings of the foregoing disclosure will suggest other modifications to those persons skilled in the relevant art. Such modifications may involve other features which are already known per se and which may be used instead of or in addition to features already described herein. Although claims have been formulated in this application to particular combinations of features, it should be understood that the scope of the disclosure herein also includes any novel feature or any novel combination of features disclosed either explicitly or implicitly or any generalization or modification thereof which would be apparent to persons skilled in the relevant art, whether or not such relates to the same invention as presently claimed in any claim and whether or not it mitigates any or all of the same technical problems as confronted by the present invention. The applicants hereby reserve the right to formulate new claims to such features and/or combinations of such features during the prosecution of the present application or of any further application derived therefrom.

1. A method of operating an array of dual-port memory cells comprising:
reading or writing to a first port of the dual-port memory cells in the array;
refreshing at a second port of the dual-port memory cells in the array;
comparing a read/write address to a refresh address; and
if the read/write address and the refresh address are different, simultaneously activating a word line associated with the first port of a first dual-port memory cell and a word line associated with the second port of a second dual-port memory cell.

2. The method of claim 1 further comprising, if the read/write address and the refresh address are the same, then activating only the word line associated with the first port of the selected dual-port memory.

3. The method of claim 1 further comprising comparing the read/write and refresh address during a memory setup time so that memory speed is unaffected.

4. An integrated circuit memory comprising:
an array of dual-port memory cells including first and second word line buses;
a refresh timer;
a refresh address generator having an input coupled to the refresh timer and an output for generator refresh addresses;
a comparator for comparing the read/write address to the refresh address; and
a row decoder having an input coupled to the comparator, and first and second outputs for selectively driving the first and second word line buses in response to the data state of the comparator.

5. The integrated circuit memory of claim 4 further comprising means for simultaneously activating a word line associated with a first port of a first dual-port memory cell and a word line associated with a second port of a second dual-port memory cell if the read/write address and the refresh address are different.

6. The integrated circuit memory of claim 4 further comprising means for activating only the word line associated with a first port of a selected dual-port memory if the read/write address and the refresh address are the same.

7. The integrated circuit of claim 4 further comprising means for comparing the read/write and refresh addresses during a memory setup time so that memory speed is unaffected.

8. The integrated circuit of claim 4 in which the first word line bus comprises a 64, 128, or 256 wide group of word lines.

9. The integrated circuit of claim 4 in which the second word line bus comprises a 64, 128, or 256 wide group of word lines.

10. The integrated circuit of claim 4 in which the dual-port memory array further comprises a first complementary bit line, a first bit line, a second complementary bit line, and a second bit line.

11. A method of operating an array of dual-port memory cells comprising:
comparing a first read/write address to a refresh address; and
if the read/write address and refresh address are different, simultaneously activating a word line associated with a first port of a first dual-port memory cell and a word line associated with a second port of a second dual-port memory cell.

12. The method of claim 11 further comprising, if the read/write address and the refresh address are the same, then activating only the word line associated with one of the ports of the selected dual-port memory.

13. The method of claim 11 further comprising using latency to compare the first read/write address and the refresh address so that memory speed is unaffected.

14. An integrated circuit memory comprising:
an array of dual-port memory cells including first and second word line buses;
a first FIFO having an input coupled to the address buffer and first and second outputs;
a second FIFO having an input coupled to the first output of the first FIFO and an output;
a comparator for comparing the second output of the first FIFO to the output of the second FIFO; and
a row decoder having an input coupled to the comparator, and first and second outputs for selectively driving the first and second word line buses in response to the data state of the comparator.

15. The integrated circuit memory of claim 14 further comprising means for simultaneously activating a word line associated with a first port of a first dual-port memory cell and a word line associated with a second port of a second dual-port memory cell if first and second read/write addresses are provided by the first and second FIFOs are different.

16. The integrated circuit memory of claim 14 further comprising means for activating only the word line associated with one of the ports of the selected dual-port memory if first and second read/write addresses provided by the first and second FIFOs are the same.

17. The integrated circuit memory of claim 14 in which the first FIFO provides a one-half clock cycle delay between the input and each of the first and second outputs.

18. The integrated circuit memory of claim 14 in which the second FIFO provides a one-half clock cycle delay.

19. The integrated circuit of claim 14 in which the first word line bus comprises a 64, 128, or 256 wide group of word lines.

20. The integrated circuit of claim 14 in which the second word line bus comprises a 64, 128, or 256 wide group of word lines.
